(19) United States
(12) Patent Application Publication
(10) Pub. No.: US 2013/0266707 A1
(43) Pub. Date: Oct. 10, 2013

(54) Dough Cutting And Dough Shaping Device

(71) Applicant: FRITSCH GMBH, Markt Einersheim (DE)

(72) Inventors: Markus Fackelmann, Sommerach (DE); Josef Hoos, Markt Einersheim (DE)

(73) Assignee: Fritsch GmbH, Markt Einersheim (DE)

(21) Appl. No.: 13/859,194

(22) Filed: Apr. 9, 2013

(30) Foreign Application Priority Data
Apr. 10, 2012 (EP) 12 163 609.6

(51) Int. Cl. A21C 5/00

(52) U.S. Cl. CPC A21C 5/003
USPC 426/502; 425/297; 426/503

(57) ABSTRACT

A dough cutting device for producing a dough piece for baking toast or the like. The dough roll is moved on a lower conveyor belt having a roll centerline oriented transverse to a conveying direction. At least one cutting knife rotating about a front rotational axis is arranged at a distance corresponding to a variably adjustable front separating gap above the lower conveyor belt, and sectionally cuts the dough roll, wherein a front connecting web of the dough roll remains.

### CROSS REFERENCE TO RELATED APPLICATION

The present application claims the benefit of European Patent Application No. 12 163 609.6 filed Apr. 10, 2012, which is fully incorporated herein by reference.

### STATEMENT REGARDING FEDERALLY SPONSORED RESEARCH OR DEVELOPMENT

Not applicable.

### FIELD OF THE INVENTION

The invention relates to a dough cutting device and also to a dough shaping device and method for producing a dough piece in the manner of the 4-piece method.

### BACKGROUND OF THE INVENTION

From the state of the art, various embodiments of devices for cutting dough rolls are known. Here, a device is being considered, by means of which a dough roll can be cut in and/or severed transverse to its longitudinal axis.

The field of application of a device of this type is the production of dough pieces for performing the so-called 4-piece method for baking toast. It is obvious that a device of this type can also be used for other dough pieces to form other types of bread or pastries.

The device known from the state of the art for this method comprises a conveyor belt on which the dough roll can be placed with its roll centerline transverse to the conveying direction of the conveyor belt. Thus, the dough roll is obviously transported transversely to its longitudinal axis. The manner in which the production of the dough piece takes place is herein immaterial, and it is of no importance, either, in which way the dough piece is placed on the conveyor belt. Furthermore, the known device for cutting in the dough piece comprises an upper holding plate which comes to abut on the dough piece during transport. Due to the transport motion of the conveyor belt, the upper stationary plate causes a resulting rotational motion of the dough roll in a counter-clockwise sense regarding the conveying direction to the right.

For cutting in and/or severing the dough roll, three spaced apart stationary cutting knifes are now arranged on the upper plate. Their cutting blades are substantially arranged at a distance corresponding to a cutting gap parallel above the conveyor belt. Due to the counter-clockwise rotational motion of the dough roll, passing the dough roll past the cutting knife causes a cutting motion on the cutting blade of the cutting knife, said cutting blade facing the conveyor belt.

Considering the form of motion of the dough roll when using the known embodiment, it becomes obvious that depending on the chosen distance between the cutting knife and the transport belt as well as on the length of the respective cutting knife, a more or lass small rest remains as a connecting web between two sections of the dough roll after the thus partial severing. The connecting web herein is material for the procedurally stable implementation of the subsequent reshaping step, in which the individual sections of the dough roll are folded at the connecting web like a hinge and the sections are supposed to thereby come to lie parallel to each other with the section of the roll centerline. The thus produced dough piece is then suitable for performing the baking of toast according to the so-called 4-piece-method.

However, it is problematic in the known embodiment for cutting the dough roll that the connecting web cannot be reliably produced in a procedurally stable manner. Instead, unavoidably occurring process fluctuations of the product to be processed will cause the connecting web to be almost completely removed in one case, and cause too large a connecting web to remain in another case. If the connecting web is almost completely severed, the desired hinge effect for the subsequent reshaping process is lost. If too large a section remains as a connecting web, this will also lead to a contrary effect in the subsequent reshaping process during reshaping and, thus, to a deformation of the entire dough piece.

### SUMMARY OF THE INVENTION

It is therefore the object of the present invention to provide a dough cutting device by means of which a dough roll can be cut in except for a rest portion more reliably and in a procedurally more stable manner than has been possible so far.

This object is attained by an embodiment according to the invention of a dough cutting device including a lower conveyor belt driven in a conveying direction-at a variably adjustable lower belt speed (vᵤ), and having a roll centerline for receiving a dough roll transverse to the conveying direction at a starting point of the conveyor belt. At least one front cutting knife rotates about a front rotational axis and is arranged at a distance corresponding to a variably adjustable front separating gap above the lower conveyor belt. The at least one front cutting knife cuts the dough roll as the dough roll passes by the at least one front cutting knife except for a remaining front connecting web. Another embodiment of the invention is a dough shaping device includes the dough cutting device and a subsequent folding device. A method according to the invention for implementing the cutting of dough rolls using the dough cutting device includes placing the dough roll on a lower conveyor belt and the dragging sectional severing the dough roll, wherein a not severed connecting web remains part of the dough roll.

First and foremost, a generic dough cutting device serves for producing a dough piece for baking toast or the like. Therein, the dough cutting device constitutes a section of the entire production process for forming the dough piece. The dough cutting device there comprises a lower conveyor belt which can be driven in a conveying direction with a lower belt speed. Not necessarily, but in a preferred design, the lower belt speed is variably adjustable.

The embodiment of the conveyor belt herein is immaterial. In the intended manner, at least a dough roll is placed on a starting point of the conveyor belt. Herein, it is necessary for the appropriate use of the dough cutting device that when the dough roll is placed, its roll centerline is oriented transverse to the conveying direction, which is to be ensured by preceding system components. Further, the generic dough cutting device comprises a front cutting knife arranged above the lower conveyor belt, by means of which the dough roll is cut when passing by. A separating gap being variably adjustable between the cutting knife and the conveyor belt decisively determines to what extent the dough roll is cut by the front cutting knife, wherein a remaining front connecting web is not severed.

According to the invention, a front cutting knife rotating about a front rotational axis is now used instead of the stationary cutting knife. By using a rotating cutting knife instead of the stationary cutting knife, new adjustment options arise for optimizing the process of cutting in the dough roll on a front severing cut.

Herein, it is particularly advantageous to use two front cutting knifes. In this case, said front cutting knives are to be positioned at a distance from each other on a common front rotational axis. It is not necessarily required that both cutting knives are arranged on a common shaft or the like. Instead, it is sufficient if the two front cutting knives have a front rotational axis located on one geometric line. Thus, two spaced apart, substantially identical severing cuts can be made in the dough roll, substantially the same front connecting web remaining in both cases. It is obvious that for this case the two front cutting knives are to be realized with matching diameters and are preferably identical. Furthermore, both cutting knives preferably are to be driven with the same rotational speed, for which purpose both cutting knives are preferably driven on the same shaft.

Further, it is particularly advantageous if, in addition to the two front cutting knives, a rear rotating cutting knife is used between them. For this purpose, the rear cutting knife is to be arranged on a rear rotational axis, wherein the arrangement of the rear rotational axis initially does not involve a geometric allocation in relation to the front rotational axis, but can simply be positioned independently of the front rotational axis. In fact, regarding the conveying direction, the rear cutting knife can not only be arranged in the same position as the front cutting knives, but also in front of or behind them. Further, the rear rotational axis can also be arranged below or above the lower conveyor belt. At least, the dough roll is cut at least in sections by the rear cutting knife in the same manner as by the front cutting knives when passing them, receiving a rear severing cut.

Due to this particularly advantageous embodiment comprising two front cutting knives and a rear cutting knife, which here both are of the rotating type, the so called 4-piece method is implemented in a particularly simplified and procedurally stable manner. In particular the thickness of the connecting web can be complied with much better in this embodiment than is possible with the known embodiments.

For optimizing the process with regard to the cutting behavior when cutting the dough roll, the rotational speed of the front cutting knife and/or the rear cutting knife is variably adjustable in an advantageous embodiment.

Herein, it is particularly advantageous if the front and/or the rear cutting knife rotates in the conveying direction. In doing so, a dragging cut is made possible when cutting the dough roll as it passes by. This immensely facilitates a gentle processing of the dough roll with as little deformation as possible. The motion in the conveying direction here relates to the circumferential motion of the cutting knife in contact with the dough roll. It is obvious that on the side opposite the rotational axis an opposite direction of movement is present.

The embodiment of the dough cutting device according to the invention is especially advantageous if above the lower conveyor belt an at least two-part upper conveyor belt is used. In this case, the latter is preferably variably adjustable in its distance from the lower conveyor belt. At least it is to be made sure that the upper conveyor belt abuts on the dough roll to be processed.

In deviation from the preceding generic embodiment, the variation is explicitly included within the scope of the invention which involves an arrangement of the front cutting knife below the lower conveyor belt if an upper conveyor belt is present. It is obvious that, for this case, the lower conveyor belt is to be realized at least in two parts laterally of the front cutting knife, the remaining front connecting web being defined by a front separating gap to the upper conveyor belt. Thus, a sectional cutting of the dough roll is made possible in accordance with the preceding description.

In the same manner as for the lower conveyor belt, it is also advantageous if the upper belt speed of the upper conveyor belt is variably adjustable. In the simplest case, the upper belt speed can be coupled to the lower belt speed via a gear transmission. However, it is particularly advantageous if the upper belt speed can be adjusted independently of the lower belt speed.

In an advantageous manner the upper belt speed is equal to the lower belt speed. The corresponding belt speed leads to a purely translational motion of the dough roll between the lower and upper conveyor belts without a rotational motion taking place. Thus, the dimensions and the position of the connecting web are defined in a particularly simple manner. Also, by using the upper conveyor belt, an uncontrolled rolling motion of the dough roll, as could happen without an upper conveyor belt, is precluded.

However, the embodiment having an upper belt speed that is higher than the lower belt speed is particularly advantageous. Hereby, the dough roll is simultaneously put in a rotational motion while being transported in the conveying direction. When considering a conveying direction to the right, the different belt speeds thus lead to a rotational motion of the dough roll in the clockwise sense. This motion of the dough roll advantageously benefits the cutting motion of the front cutting knives rotating in the opposite direction.

In the case of an embodiment having the front rotational axis below the lower conveyor belt, the parameters are obviously reversed so that the lower belt speed is preferably higher than the upper belt speed so that a rotational motion of the dough roll against the rotational direction of the front cutting knife is present, too.

With regard to the arrangement of the rear cutting knife in relation to the lower conveyor belt, various embodiments arise.

In a first advantageous variation, the rear rotational axis is arranged in the same way as the front rotational axis above the lower conveyor belt. Further, the positioning of the rear cutting knife takes place such that the rear cutting knife comes at least close to the lower conveyor belt. Depending on the design of the dough cutting device with or without an upper conveyor belt and depending on the belt speeds of the lower and upper conveyor belts, a rotational motion of the dough roll taking place during the transport in the conveying direction leads to a complete severing of the dough roll even if a remaining gap is present between the cutting knife and the conveyor belt. Therefore, it is not necessarily required that the rear cutting knife has to reach the lower conveyor belt to touch it in order to completely sever the dough roll by forming a rear severing cut.

In a second embodiment variation, the rear rotational axis is now arranged below the lower conveyor belt. Also, a complete severing of the dough roll is advantageously accomplished if the rear cutting knife in this embodiment comes at least close to the upper conveyor belt, analogously to the first variation.

Yet, it is also possible to choose a third embodiment in which the rear cutting knife cuts through a supporting surface of an at least two-part upper conveyor belt as well as through a supporting surface of an at least two-part lower conveyor belt. For the severing it is of no consequence whether the rear rotational axis herein is arranged above the upper conveyor belt or below the lower conveyor belt. At least it is obvious herein to design the lower conveyor belt as well as the upper conveyor belt at least in two parts, the rear cutting knife being interposed. By this design it is made sure in any case that the dough roll is completely severed at the rear severing cut.

A fourth embodiment variation is particularly advantageous in which, like in the first variation, the rear rotational axis is again arranged above the lower conveyor belt, but the rear cutting knife is arranged with a variable rear separating gap above the lower conveyor belt. Thus, as is the case at the front cutting knife, the dough roll being transported past is severed also at the rear cutting knife except for a remaining rear connecting web.

In a further advantageous fifth alternative, the rear rotational axis is now, like in the second variation, again arranged below the conveyor belt, but, analogously to the fourth variation, the rear cutting knife is arranged with a variably adjustable rear separating gap below the upper conveyor belt. Analogously, in this embodiment the dough roll is advantageously severed except for a remaining rear connecting web.

In a particularly preferred embodiment, the adjustability of the rear cutting knife of the fourth or fifth variation is realized such that the remaining rear separating gap can be reduced to an extent that, like in the first and second variations, a complete severing becomes possible.

In the case of the complete severing of the dough roll by the rear cutting knife, the arrangement of the rear cutting knife regarding the conveying direction relative to the front cutting knife is initially optional. Thus, the rear cutting knife can be arranged at the same point in the transport path as the front cutting knives so that a very short structural length is achieved. If the lower conveyor belt is realized at least in two parts, the rear cutting knife can be arranged below the lower conveyor belt in the same position as the front cutting knives. In the alternative with a two-part lower conveyor belt the rear cutting knife can also be arranged on a common shaft with the front cutting knives with a thus corresponding front and rear rotational axis, for which obviously a larger diameter of the rear cutting knife in relation to the front cutting knife is required.

“At the same point in the transport path” herein relates to the conveying direction, i.e. that the upper and lower cutting knives can act on the dough roll simultaneously.

If a remaining rear connecting web is required or desired and the rear cutting knife is arranged above the lower conveyor belt, it is particularly advantageous if regarding the conveying direction the rear cutting knife is positioned at a sufficient distance upstream of the front cutting knife or downstream of the front cutting knife. In that way it is made possible to position the front connecting web in relation to the rear connecting web in a deviating position during a potential rotational motion of the dough roll.

When the rear rotational axis is positioned below the lower conveyor belt, the rear cutting knife can be positioned in a particularly advantageous manner at the same point in the transport path as the front cutting knife. Thus, it is advantageously possible to create a remaining rear connecting web at the opposite side of the front connecting web in relation to the roll centerline.

An advantageous cutting of the dough roll by means of rotating cutting knives is achieved if the circumferential speed of the front cutting knife and/or of the rear cutting knife is higher than the lower belt speed and lower than twice the lower belt speed. Within this speed range, a procedurally stable cutting of the dough roll is made possible, wherein it is particularly advantageous to adjust the circumferential speed such that it roughly corresponds to 1.05 times the upper belt speed. Thus, an at least sectional severing of the dough roll is made possible with a slow gentle cut.

Furthermore, it is particularly advantageous if the upper belt speed is adjustable relative to the lower belt speed in such a way that the front connecting web has a defined target position relative to the roll centerline when it is discharged at the end of the conveyor belt. This means that due to the relative speeds of the lower and upper belt speeds, a rotational motion of the dough roll is caused, which consequently effects a rotation of the front connecting web about the roll centerline. By accordingly adjusting the upper belt speed, the position of the front connecting web at the end of the dough cutting device thus can be determined in a simple and advantageous manner.

This is especially advantageous when using the so-called 4-piece-method because here, for further processing, the connecting web is in a particularly preferred position in the conveying direction behind the roll centerline, i.e. at 9 o'clock in the case of a conveying direction running to the right.

Further, it is particularly advantageous if in the design comprising a front and rear connecting web, taking into account the distance between the front and rear cutting knives, the upper belt speed is adjustable in such a manner that the front connecting web is positioned roughly at the opposite side in relation to the roll centerline. This means that on the cut-in dough roll the front connecting web is present offset by 180° from the rear connecting web. This advantageously facilitates the subsequent reshaping in the so-called 4-piece method.

Further, it is particularly advantageous if the dough cutting device is supplemented by a folding device to act as a dough shaping device. For this purpose, the folding device in the arrangement adjacent to the dough cutting device comprises at least one conveyor belt on which the dough roll cut in by the dough cutting device is transported. With regard to this, it is initially immaterial whether the dough cutting device shares a conveyor belt with the folding device or if the folding device comprises a conveyor belt which is independent of the dough cutting device or if, for example, the lower conveyor belt of the dough cutting device constitutes a first conveyor belt and the folding device subsequently comprises a second conveyor belt.

At least, the folding device comprises elements for reshaping the dough roll which are oriented substantially upright and are arranged above the conveyor belt. First of all, they comprise a centrally arranged reshaping stop. With regard to the conveying direction, considering the preceding rear severing cut at the rear cutting knife, the reshaping stop is positioned accordingly in alignment with the latter, i.e. obviously in the middle with respect to the arriving dough roll.

Further, the elements needed for reshaping comprise two folding elements arranged symmetrically with respect to the middle.

In this case, it is particularly advantageous if the reshaping stop has a wedge-shaped form oriented against the conveying direction. Thereby a bilateral folding of the dough rolls is advantageously facilitated when the dough piece, which is severed or at least cut-in in the middle position, arrives at the reshaping stop.

In an advantageous embodiment the folding means are formed by reshaping belts which are moved in the conveying direction and whose distance from each other decreases in the conveying direction. First, the two outer ends of the dough roll come to abut on the reshaping belts, a corresponding reshaping of the dough roll taking place by folding it at the front connecting webs. This is followed by a repositioning of the individual sections of the dough roll by the respective sections of the roll centerline being oriented in a parallel position.

The design of the folding means is particularly advantageous if it comprises a row of consecutive reshaping rolls. The two rows herein are arranged symmetrically opposite with respect to the middle of the folding device, wherein, like in the design with reshaping belts, the row extends in the conveying direction and the reshaping rolls of the two rows have a continuously decreasing distance from each other. The rotational axis of the reshaping rolls is vertical to the conveyor belt. It is advantageous that the individual reshaping rolls cannot only be arranged in a straight line, but the row of reshaping rolls can also extend in a curved shape, which herein in contrast to the reshaping belt can not only be formed convex, but also concave.

Here, the reduced adhesion of dough and dirt to the reshaping rolls as well as the more easier cleanability are especially advantageous. Also, it is avoided that dough residue and dirt accumulate within the reshaping belts running around the vertical axes, since removing the dough residue and dirt from there would be complicated and dough residue and dirt particles could at any time fall down onto the conveyor belt running below and could contaminate the dough pieces.

In an advantageous embodiment, all reshaping rolls are driven as folding means, a driven toothed belt preferably driving all reshaping rolls at once.

Further, it is possible to first effect a reshaping in the folding device by means of a symmetrical row of reshaping rolls and to subsequently complete the reshaping by means of a symmetrical arrangement of vertically oriented conveyor belts or to prevent a reverse shaping, respectively.

The design of the folding device is particularly advantageous if it comprises two successively arranged separate conveyor belts. Herein it is immaterial whether a first conveyor belt is formed by the lower conveyor belt of the dough cutting device. It is at least advantageous if the first conveyor belt is driven with a speed corresponding to the lower conveyor belt. On the other hand, the speed of the second subsequent conveyor belt of the folding device has to be chosen to be significantly lower. To this effect, the speed of the first conveyor belt should be at least 50% higher than the speed of the second conveyor belt. However, a speed of the preceding first conveyor belt which is at least double the speed of the following second conveyor belt is particularly preferred.

Speeds of for example 50m/min for the lower conveyor belt of the dough cutting device as well as for the first conveyor belt of the folding device and 20 m/min for the second conveyor belt of the folding device are advantageous.

It is advantageous in this embodiment that when the dough rolls arrive at the reshaping stop, respectively at the folding means, a kind of folding on said reshaping stop, respectively folding means, and on the connecting webs takes place due to the high kinetic energy, and a relative motion begins above the conveyor belt of the folding device. The speed difference makes sure that a transition from the static friction of the dough roll lying on the conveyor belt into a sliding friction during reshaping takes place. In contrast, a corresponding speed at a high static friction would bear the risk of the dough roll being squeezed through the folding device despite folding means and connecting web as a hinge.

It is particularly advantageous in this embodiment if the separating point between the first and the second conveyor belts is arranged in the starting area of the reshaping stop and the folding means. Herein, the separating point can be arranged directly upstream of the reshaping stop, respectively the folding means, as well as preferably downstream of the reshaping stop and the folding means. Due to the gap formed by the separating point in the supporting surface of the dough roll, the absent conveyor belt in this place does not negatively decelerate the reshaping process. Also, the partially reshaped dough piece can be brought into shape with an adapted lower speed, i.e. it can be reshaped completely axially parallel and can be transferred to subsequent system components.

For the dough cutting device according to the invention, a novel process for cutting in a dough roll is presented, wherein in particular a dough cutting device according to the preceding description is employed. Herein, a dough roll placed on a lower conveyor belt is transported in a conveying direction. The significant part is the sectional severing of the dough roll by means of a rotating front cutting knife which herein effects a dragging cut due to the adequate choice of the circumferential speed of the cutting knife. Thus, the dough roll is severed in sections, receiving a front severing cut while a not severed connecting web remains.

Herein, it is particularly advantageous if by means of an upper conveyor belt abutting on the dough roll, the latter is put into rotation. Thus, it is made possible that the remaining connecting web has a predetermined target position relative to the roll centerline of the dough roll. Herein, it is particularly advantageous if the dough roll performs a rotational motion in the clockwise sense, the conveying direction running to the right. This benefits not only the positioning of the connecting web, but also in particular the cutting motion of the front cutting knife.

Further, it is particularly advantageous if following the cutting by the dough cutting device, the dough roll is shaped by means of a dough shaping device. First, four sections of the dough roll are formed, which are either completely separate from one another or at least in two cases are connected to each other by a front connecting web. By pivoting the sections against each other, the four sections are positioned such that the roll centerlines of the sections lie substantially parallel to one another.

### BRIEF DESCRIPTION OF THE DRAWINGS

In the following figures, exemplary embodiments of a dough cutting device as well as an example of a folding device will be outlined.

FIG. 1 shows a first embodiment of a dough cutting device comprising a front and rear cutting knife at the same point in a lateral view;

FIG. 2 shows another embodiment with a rear cutting knife following the front cutting knife for a complete severing in a lateral view;

FIG. 3 shows a top view of the embodiment of FIG. 2;

FIG. 4 shows another embodiment with an additional upper conveyor belt in a lateral view;

FIG. 5 shows a top view of the embodiment of FIG. 4;

FIG. 6 shows a further embodiment variant for creating a front and a rear connecting web in a lateral view;

FIG. 7 shows a top view of the embodiment of FIG. 6;

FIG. 8 shows a further embodiment comprising a rear cutting knife arranged below the lower conveyor belt in a lateral view;

FIG. 9 shows a first embodiment of a folding device with reshaping belts;

FIG. 10 shows a second embodiment of a folding device with reshaping rolls.

### DETAILED DESCRIPTION OF THE EXAMPLE EMBODIMENTS

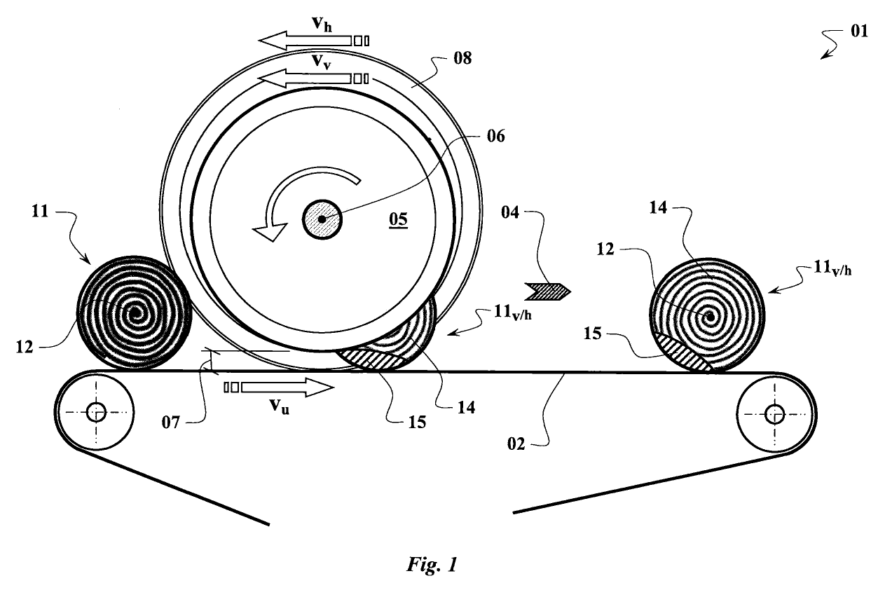

In FIG. 1, a first simple embodiment of a dough cutting device 01 according to the invention comprising a front cutting knife 05 and a rear cutting knife 08 is outlined. The lower conveyor belt 02 arranged on the lower side is visible. Lying on said lower conveyor belt 02, the dough rolls 11 are transported. Said dough rolls 11 are placed on the lower conveyor belt 02 in such a manner that the roll centerline 12 of the dough roll 11 is situated transverse to the conveying direction 04 of the conveyor belt 02. The conveyor belt 02 herein moves with a lower belt speed vᵤ.

To maintain the desired front connecting web 15 on the dough roll 11_{v/h}, which is cut in sections and has the illustrated front severing cut 14 and the rear severing cut 16 (not illustrated) at the back, the front cutting knife 05 is situated so as to rotate about the front rotational axis 06 with a front separating gap 07 above the lower conveyor belt 02. The front cutting knife 05 rotates in the counter-clockwise sense and the direction of movement of the cutting knife 05 on its circumference thus corresponds to the conveying direction 04 during the cutting of the dough roll 11. Due to the free movability of the dough roll 11 in this embodiment, in particular neither the position nor, among other things, the exact realization of the connecting web 15 are guaranteed; yet nevertheless, the width of the connecting web 15 is well adjustable also by means of this embodiment according to the invention, by varying the size of the front separating gap 07.

Here, the rear cutting knife 08 is situated between two front cutting knives 05 at about the same point within the transport path regarding the conveying direction 04. The rear cutting knife 08 is positioned such that a complete severing of the dough roll 11 with a rear severing cut 16 takes place. Thus, the entire dough cutting device 01 can be designed as a short structure. The choice of the speed of the cutting knives 05 and 08 depends in particular on the lower belt speed vᵤ of the lower conveyor belt 02.

In this regard, the circumferential speed vᵥ of the front cutting knife, respectively the circumferential speed vₕ of the rear cutting knife 08, should be chosen to be higher than the lower belt speed vᵤ.

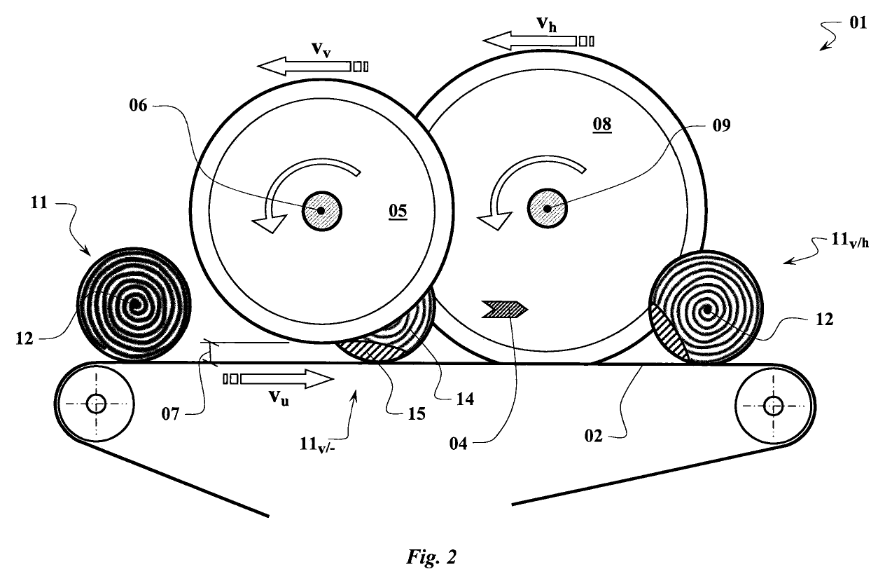

In FIG. 2, an alternative embodiment of a dough cutting device 01 is outlined, in which, compared to FIG. 1, the rear cutting knife 08 is now arranged offset in the conveying direction 14. Further, it is outlined in this embodiment that the rear cutting knife 08 cuts through the supporting plane of the lower conveyor belt 02. Thus, it is made sure in any case that the dough roll 11 is severed completely with a rear severing cut 16.

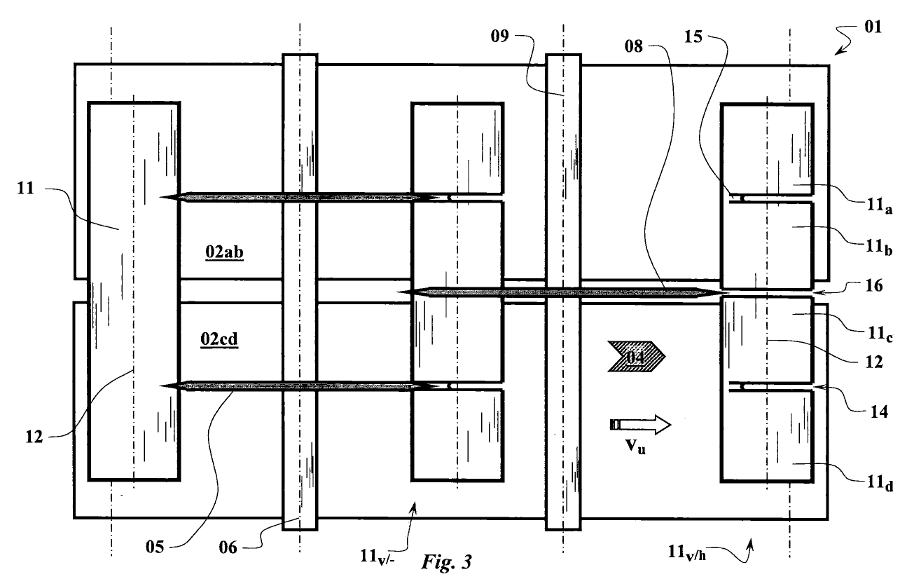

With regard to this, FIG. 3 outlines a top view of the exemplary embodiment of the dough cutting device 01 of FIG. 2. First of all, the design of the lower conveyor belt 02 comprising two sections 02ab and 02cd is visible. At the starting point of the conveyor belt 02 the dough roll 11 is placed with the roll centerline 12 transverse to the conveying direction 04. In this embodiment, first, the cutting-in of the dough roll 11 by means of the two front cutting knives 05 takes place, said cutting knives 05 being arranged at a distance from each other on a common rotational axis 06. During this, a front severing cut 14 is produced, while the front connecting web 15 remains. The cutting by means of the front cutting knives 05 is followed by the severing of the cut-in dough roll 11v/- by means of the rear cutting knife 08 being positioned on the rear rotational axis 09. As a result, a cut-in dough roll 11_{v/h}, is produced, comprising four sections 11a, 11b, 11c, 11d.

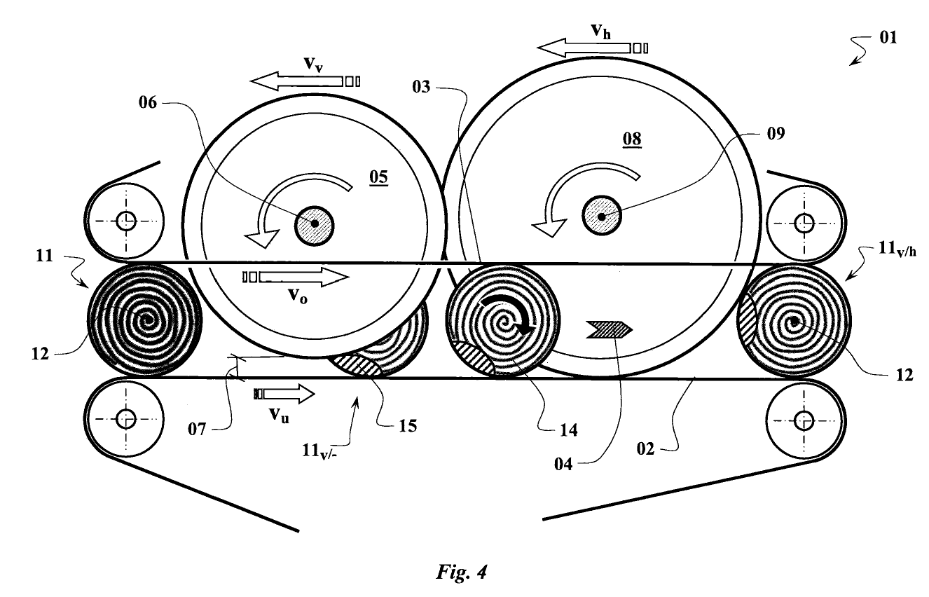

In FIG. 4, the dough cutting device 01 is now supplemented by an upper conveyor belt 03. Compared to the embodiment of FIG. 2, the dough cutting device 01 again comprises a lower conveyor belt 02, a front cutting knife 05 at a distance corresponding to a front separating gap 07 above the lower conveyor belt 02 and also a rear cutting knife 08 following the front cutting knife 05, which 08 causes a complete severing of the dough roll 11. In this embodiment of the dough cutting device, the use of the upper conveyor belt 03 is material, by which a targeted positioning of the dough roll 11 is made possible. In contrast to previous embodiments, in which the exact position of the dough roll 11 about the roll centerline 12 cannot be determined, it is possible in this embodiment to influence the exact rotational motion of the dough roll 11 by the dough roll 11 abutting on the lower conveyor belt as well as on the upper conveyor belt.

In the case of corresponding belt speeds between the lower belt speed vᵤ of the lower conveyor belt 02 and the upper belt speed vₒ of the upper conveyor belt 03, the transport of the dough roll 11 obviously takes place in a purely translational fashion. Advantageously, however, the upper conveyor belt 03 is driven with a higher belt speed vₒ in relation to the lower belt speed vᵤ. Thereby, a rotational motion of the dough roll 11 in the clockwise sense (conveying direction 04 to the right) is effected. This makes it possible, in particular, to move the front connecting web 15 to the desired position relative to the roll centerline 12 when the dough roll 11_{v/h} is discharged.

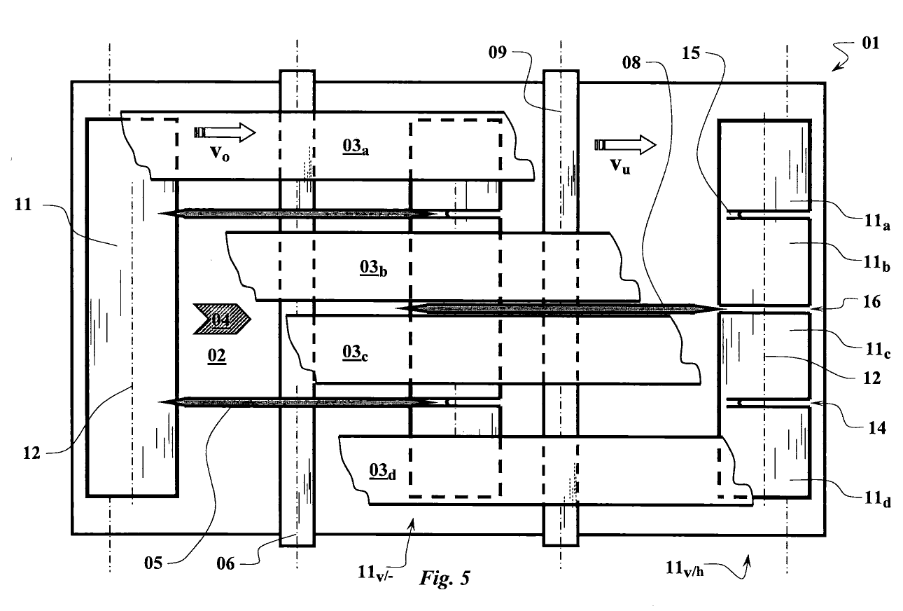

FIG. 5 outlines a top view of the embodiment of FIG. 4, wherein the design of the upper conveyor belt 03 comprising four sections 03a, 03b, 03c and 03d is visible. Herein, the distance between the front cutting knives 05 is advantageously adjustable, wherein a corresponding spacing in the upper conveyor belts 03a to 03b, 03 c to 03d must be present or, in the alternative, at least the outer conveyor belts 03a, 03d must also be adjustable.

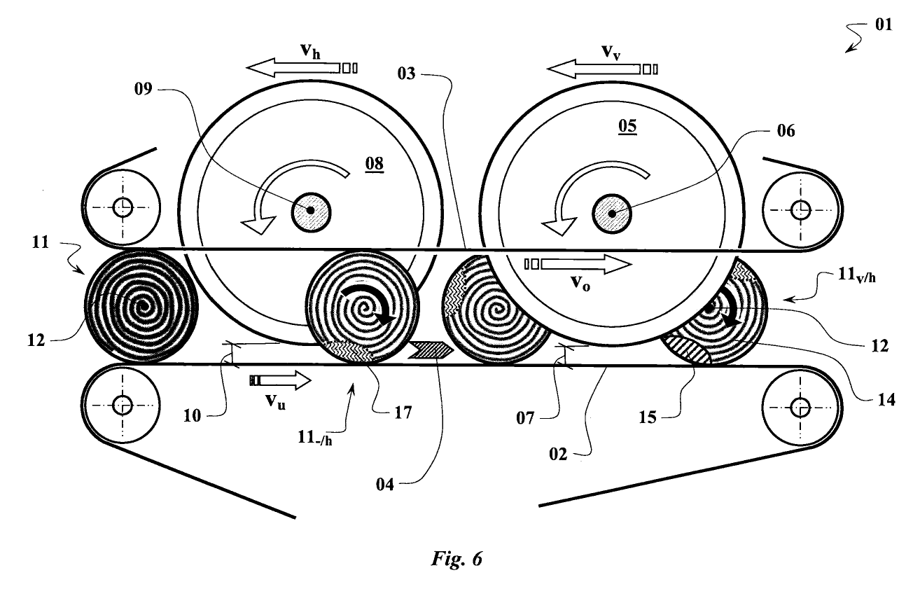

In FIG. 6, an embodiment is now disclosed which allows a cutting of the dough roll 11 while maintaining front connecting webs 15 as well as now a rear connecting web 17. For that purpose, the rear cutting knife 08 is also positioned with its rear rotational axis 09 above the lower conveyor belt 02 so that a rear separating gap 12 is created. Thus, when the dough roll 11 is transported past, said dough roll 11 is now no longer completely severed by the rear cutting knife 08, but is severed only in sections while maintaining a rear connecting web 17, as is the case with the front cutting knife 05. By an adequate choice of the distance between the front rotational axis 06 and the rear rotational axis 09 as well as of the chosen relative belt speeds between the lower conveyor belt 02 and the upper conveyor belt 03, the position of the rear connecting web 17 relative to the front connecting web is determined with regard to the roll centerline 12.

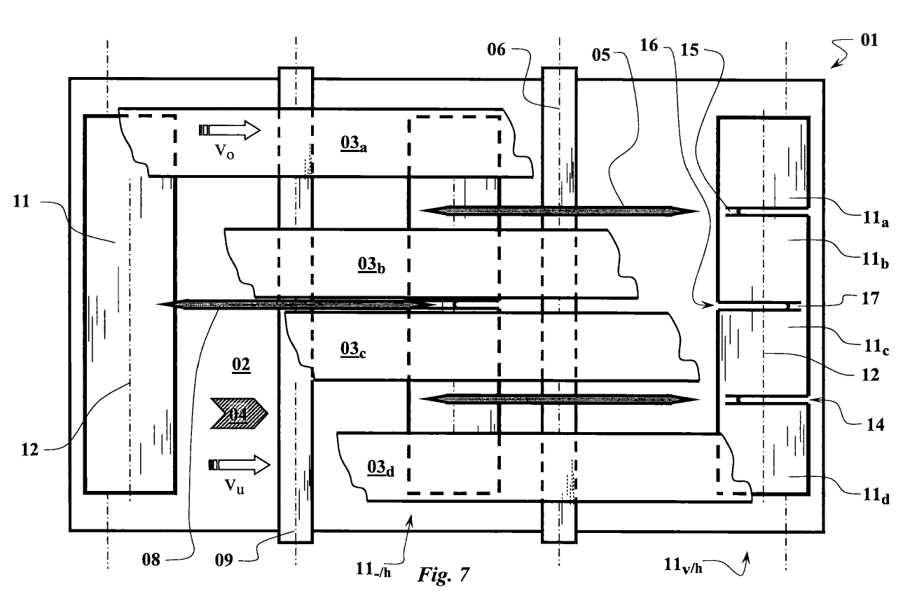

In this regard, FIG. 7 outlines a top view of the embodiment of FIG. 6. In correspondence to the embodiment of FIG. 5, the design of the lower conveyor belt 02 and the multi-part upper conveyor belts 03a to 03d is visible. In contrast to the preceding embodiment, however, the dough roll 11 is not severed completely here by the rear cutting knife 08, but at the rear severing cut 16 a rear connecting web 17 remains, which 17 is advantageously positioned when the cut-in dough roll 11_{v/h} is discharged so that the front connecting web 15 lies at the rear regarding the conveying direction 04, and the rear connecting web 17 is positioned preceding the roll centerline 12 in the conveying direction 04.

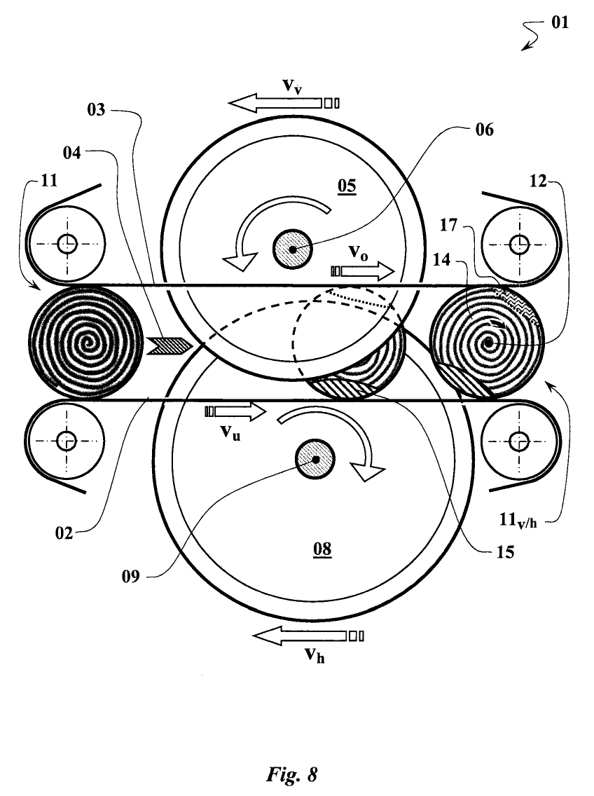

In deviation from the preceding embodiments, FIG. 8 outlines an exemplary dough cutting device 01 in which 01 in contrast the rear rotational axis 09 of the rear cutting knife 08 is arranged below the lower conveyor belt 02. This allows a short-structured embodiment, in particular when maintaining a front and also a rear connecting web 15, 17. Necessarily, herein, the rear cutting knife 08 cuts through the lower conveyor belt 02, which 02 is to be designed at least in two parts. Due to the distance of the rear cutting knife 08 from the upper conveyor belt 03, the thickness of the rear connecting web 17 can be determined.

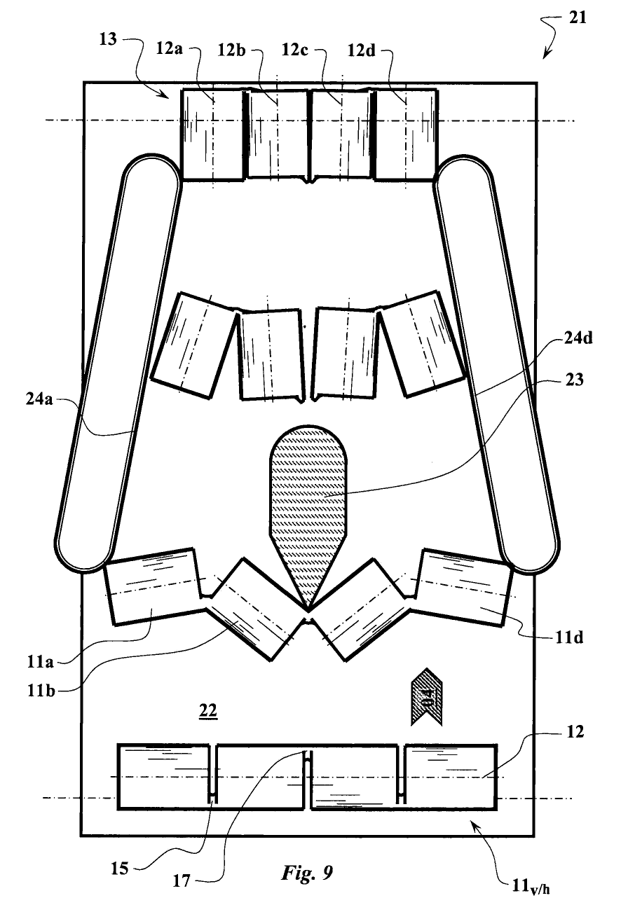

In FIG. 9, in supplementation of the preceding dough cutting device 01, a first embodiment example for a folding device 21 is outlined, which 21 advantageously follows the dough cutting device 01. Herein, the cut-in dough roll 11_{v/h} is led towards reshaping elements 23, 24, wherein centrally above the conveyor belt 22 a wedge-shaped reshaping stop 23 is positioned. Said reshaping stop 23 causes a separation of the dough roll 11_{v/h} on both sides of the reshaping stop 23. Thereby, a folding of the individual sections 11a, 11b, 11c and 11d of the dough roll 11_{v/h} is induced. Folding the individual sections 11a to 11d of the dough roll 11_{v/h} against each other on both sides of the central reshaping stop 23 is ensured by reshaping belts 24a and 24d arranged in a narrowing fashion on both sides. As a result, the individual sections of the dough roll 11 are output such that a reshaped dough piece 13 with sections 12a to 12d of the roll centerline 12 of the dough roll 11_{v/h} the sections being positioned parallel to each other, respectively, is produced as a dough piece 13 suitable for baking toast.

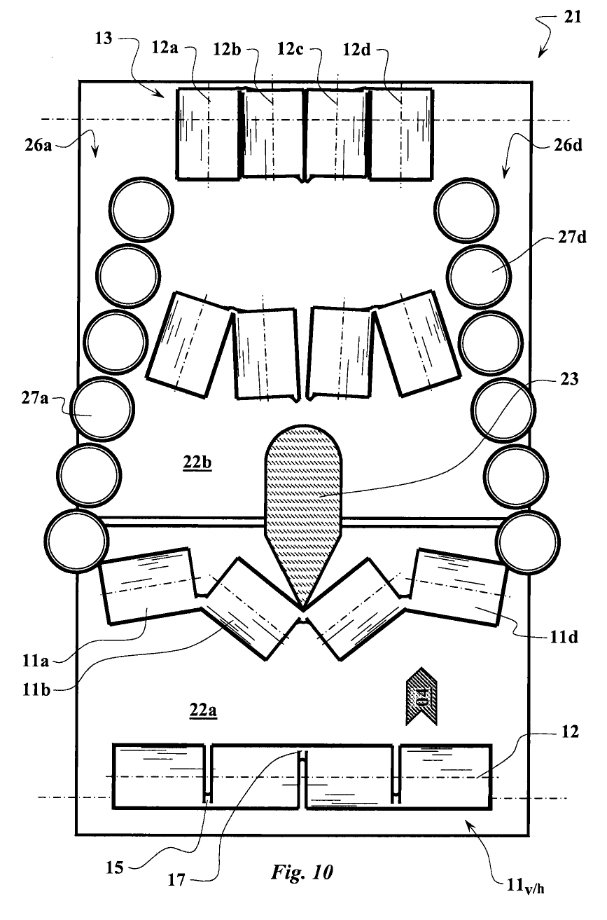

In FIG. 10, a folding device 21 being an alternative to the embodiment of FIG. 9 is outlined, wherein now, instead of the reshaping stops, rows of reshaping rolls 26a, 26d are used, opposing each other symmetrically on both sides of the middle and being arranged in the conveying direction 04. The distance of the opposite individual reshaping rolls 27a and 27d herein continuously decreases so as to effect the respective folding of the dough roll 11_{v/h} to obtain a dough piece 13.

Further, FIG. 10 outlines a first conveyor belt 22a and a second conveyor belt 22b following at the separating point with little distance. Here, the separating point is arranged below the reshaping stop 23 and below the reshaping roll rows 26a, 26d. Consequently, during the reshaping process the cut-in dough piece 11_{v/h} does not lie on the conveyor belt 22 for a short moment. This benefits the reshaping in that the hinge-type reshaping process is not negatively decelerated by a static friction on the conveyor belt. Further, the second conveyor belt 22b is driven in the conveying direction 04 with a lower speed than the first conveyor belt 22a.

1. A dough cutting device for producing a dough piece, said dough cutting device comprising:
a lower conveyor belt driven in a conveying direction at a variably adjustable lower belt speed (vᵤ), and having a roll centerline for receiving a dough roll transverse to the conveying direction at a starting point of the conveyor belt; and
at least one front cutting knife rotating about a front rotational axis and arranged at a distance corresponding to a variably adjustable front separating gap above the lower conveyor belt, said at least one front cutting knife cutting the dough roll as the dough roll passes by said at least one front cutting knife except for a remaining front connecting web.

2. The dough cutting device according to claim 1, in which two front cutting knives are arranged at a distance from each other on a common front rotational axis, and a rear cutting knife is arranged between the front cutting knives and rotates about a rear rotational axis to cuts the dough roll as the dough roll passes by said rear cutting knife.

3. The dough cutting device according to claim 2, in which at least one of the at least one front cutting knife and the rear cutting knife rotates in the conveying direction.

4. The dough cutting device according to claim 1, in which an at least two-part upper conveyor belt is arranged a distance above the lower conveyor belt, said distance being variably adjustable above the lower conveyor belt, and the at least two-part upper conveyor is driven in the conveying direction at an upper belt speed (vₒ) which is variably adjustable, the upper conveyor belt coming to abut on the dough roll.

5. The dough cutting device according to claim 4, in which the upper belt speed (vₒ) is equal to the lower belt speed (vᵤ), and during transport, the dough roll is transported one of 1) without a rotational motion and 2) the front rotational axis is arranged above the upper conveyor belt having an upper belt speed (vₒ) higher than the lower belt speed (vᵤ), whereby during transport the dough roll is rotated against a rotational direction of the front cutting knife.

6. The dough cutting device according to claim 2, in which the rear rotational axis is arranged above the lower conveyor belt and the rear cutting knife comes one of 1) at least close to the lower conveyor belt, 2) the rear rotational axis is arranged below the lower conveyor belt and the rear cutting knife comes at least close to the upper conveyor belt, and 3) the rear cutting knife cuts through the supporting surface of an at least two-part lower conveyor belt and a contact surface of an at least two-part upper conveyor belt, thereby completely severing the dough roll at a rear severing cut.

7. The dough cutting device according to claim 2, in which one of 1) the rear rotational axis is arranged above the lower conveyor belt and the rear cutting knife is arranged with a variably adjustable rear separating gap above the lower conveyor belt, and 2) the rear rotational axis is arranged below the lower conveyor belt and the rear cutting knife is arranged with a variably adjustable rear separating gap below the upper conveyor belt, thereby severing the dough roll except for a remaining rear connecting web.

8. The dough cutting device according to claim 1, in which at least one of a circumferential speed (vᵥ) of the at least one front cutting knife and a circumferential speed (vₕ) of the rear cutting knife is higher than the lower belt speed (vᵤ) and lower than twice the lower belt speed (vᵤ).

9. The dough cutting device according to claim 4, in which the upper belt speed (vₒ) is adjustable in relation to the lower belt speed (vᵤ), such that the front connecting web has a defined target position relative to the roll centerline when the dough roll is discharged at an end of the conveyor belt.

10. The dough cutting device according to claim 4, in which the upper belt speed (vₒ) is adjustable in relation to the lower belt speed (vᵤ), such that the front connecting web is arranged offset by about 180° from the rear connecting web in relation to the roll centerline.

11. A dough shaping device including a dough cutting device according to claim 1, including at least one conveyor belt on which a dough roll is transported in a conveying direction, and a folding device following the dough cutting device said folding device including a centrally arranged reshaping stop and two folding elements arranged above the at least one conveyor belt and symmetrical with respect to a middle of the at least one conveyor belt.

12. The dough shaping device according to claim 11, in which the reshaping stop has a wedge-shaped form oriented against the conveying direction and the folding elements are reshaping belts which are moved in the conveying direction and whose distance from each other decreases in the conveying direction.

13. The dough shaping device according to claim 11, in which the reshaping stop has a wedge-shaped form oriented against the conveying direction and the folding elements are multiple reshaping rolls which are rotatable about an axis vertical to the at least one conveyor belt and which are arranged one after the other in the conveying direction and whose distance from each other decreases in the conveying direction.

14. The dough shaping device according to claim 11, in which a first conveyor belt moves with at least a 50% higher speed in relation to a second conveyor belt directly adjacent in the conveying direction, wherein a point of separation between the first conveyor belt and the second conveyor belt is located directly ahead of or below the reshaping stop and the folding elements.

15. A process using a dough cutting device according to claim 1, wherein a dough roll placed on a lower conveyor belt is transported in a conveying direction and the dough roll is dragging sectional severed by the rotating at least one front cutting knife, wherein a not severed connecting web remains part of the dough roll.

16. The process according to claim 14, in which the dough roll is set in rotation by an upper conveyor belt so that the connecting web is situated in a predetermined position relative to a roll centerline.

17. The process according to claim 11, which the dough roll is reshaped after being cut using a dough shaping device that pivots four sections of the dough roll so that the four sections of the roll centerline are substantially parallel to one another.

18. The dough cutting device according to claim 2, in which a rotating speed of at least one of the front cutting knife and rear cutting knife is variably adjustable.
